(19) United States
(12) Patent Application Publication
(10) Pub. No.: US 2019/0038386 A1
(43) Pub. Date: Feb. 7, 2019

(54) TOOL FOR 3D ADJUSTMENT OF MUSCLE POSITION, AND ARTICULATOR FOR 3D ADJUSTMENT OF MUSCLE POSITION

(71) Applicant: Eiji Yamaguchi, Sendai-shi, Miyagi (JP)

(72) Inventor: Eiji Yamaguchi, Sendai-shi, Miyagi (JP)

(21) Appl. No.: 16/074,567

(22) PCT Filed: Oct. 26, 2016
(86) PCT No.: PCT/JP2016/081789

§ 371 Date: Aug. 1, 2018

(30) Foreign Application Priority Data
Feb. 2, 2016 (JP) 2016-018447

(51) Int. Cl. A61C 11/02; A61C 19/05; A61C 11/00

(52) U.S. Cl. CPC A61C 11/02; A61C 11/003; A61C 19/05

(57) ABSTRACT

A tool for 3D adjustment of a muscle position used at the adjustment of a jaw position is provided with a first member attached in a position corresponding to left and right molar regions, including a plurality of convex parts and a second member attached to a position opposing at least the first member, wherein the first member has a surface facing the second member provided with a plurality of convex parts, the convex parts having distal ends capable of sliding on an upper surface of the second member, and the second member has a surface facing at least the first member, the surface being a substantially flat surface. By using the articulator for 3D adjustment of a muscle position, the occlusal position is caused to correspond to the centric occlusal position with good accuracy, making it possible to produce a prosthetic appliance.

### TECHNICAL FIELD

The present invention relates to a tool for 3D adjustment of a muscle position and an articulator appropriate for 3D adjustment of a muscle position that are used in medical treatment for matching a centric position and a centric occlusal position of a patient having lost a jaw position. Particularly the present invention relates to a tool for 3D adjustment of a muscle position and an articulator for 3D adjustment of a muscle position that are used for production of partial dentures to loss of molar regions and complete dentures. Further, the present invention relates to a tool used for general production of prosthetic appliances to loss of a plurality of teeth relating to a jaw position balance, such as production of prosthetic appliances required for occlusal medical treatment.

### BACKGROUND ART

There is complete denture medical treatment as medical treatment representative of medical treatment for matching a centric position and a centric occlusal position of a patient having lost a jaw position. A tool for 3D adjustment of a muscle position disclosed in the present specification is not limited to production of the complete denture medical treatment and may be applied also to production of partial dentures, but hereinafter, an explanation will be made primarily of the complete denture medical treatment as the representative medical treatment.

Here, “jaw position” indicates a three-dimensional position of a lower jaw to an upper jaw and defines a contact positional relation of the upper and lower jaws required at mastication. An upper jaw bone forms a part of a skull bone and therefore a position thereof is fixed. On the other hand, a lower jaw bone has left and right jaw joints and moves not only vertically but also horizontally. The centric position and the centric occlusal position are defined in various manners, and here the centric position is defined as a tapping point and the centric occlusal position is defined as an apex start position. In addition, a stable position of the condyle is assumed to be equal to the centric position.

In the complete denture medical treatment, it is required to optimize the lower jaw position to the upper jaw position in such a manner that lower jaw dentition and upper jaw dentition stably occlude in a state where a jaw joint and a neuromuscular mechanism are harmonized, that is, in such a manner that the centric position and the centric occlusal position are matched. The complete denture medical treatment largely depends on skills, experiences and perception of an operator, and among them, alignment of the lower jaw is a point greatly affecting the medical treatment effect. However, it is difficult to perform the alignment, requiring a lot of labors and time for complete denture production. Also, for a patient whose anterior teeth and the like partially remain, the patient has lost the jaw position and it is important to match the centric position and the centric occlusal position as similar to the complete denture.

For acquiring adjustment of the jaw position and stable mastication to create match between the centric position and the centric occlusal position, a bite taking method by a bite plate using paraffin wax is generally executed. However, uniformity is caused by a softening temperature of the paraffin wax, and misalignment is generated by a hard portion of the wax at chewing, possibly inducing the condyle to a position different from the stable position of the condyle. Further, since the wax is hardened in the contacting state as the temperature falls, the condyle cannot move to the stable position from the guide position of the contact surface.

Conventionally, there is known a tool that three-dimensionally adjusts a muscle position used in bite taking at the production of the complete dentures. The tool has marking blades disposed in left and right molar regions of an upper jaw base floor adapted for the upper jaw and recording blocks disposed in left and right molar regions of a lower jaw base floor adapted for the lower jaw with distal surfaces of the marking blades abutting on the recording blocks. The lower jaw position to the upper jaw position is recorded by adjusting a whole height and a left-right height of the recording block or the marking blade in a state where the above components are attached in a mouth cavity. Further, there has been developed a bite taking rim that places a metallic tool with three hemispheres connected on a wax rim of the lower jaw and acquires a predetermined jaw-jaw relation at tapping (Patent Literature 1 and Non-Patent Literature 1).

The tool disclosed in Patent Literature 1 is attached on the left and right molar regions of the upper jaw base floor and the lower jaw base floor with the marking blade and the recording block being opposed to each other by a dental mechanic in a state where the upper jaw and lower jaw base floors are attached on a model for upper and lower-jaw work of a patient that is attached on the articulator.

Next, a dentist attaches the tool into the mouth cavity of the patient in a state of being attached on the upper jaw and lower jaw base floors to perform the bite taking. At this time, the tool is taken out of the mouth cavity of the patient in such a manner that contact surfaces of the marking blades and the recording blocks are contacted equally in the left and right sides with the whole height being not too high or too low. After the recording block is grinded or resins are added to the recording block, the tool is reattached into the mouth cavity of the patient. In addition, an occlusal position recording member is applied on an upper surface of the recording block for occlusion, recording a trace on which the marking blade abuts as unevenness.

Next, after the tool is taken out of the mouth cavity of the patient in a state of being attached on the upper jaw and lower jaw base floors, the tool is reattached on the model for upper and lower-jaw work fixed to the articulator by a dental mechanic. At this time, the upper jaw and lower jaw base floors are occluded for the state recorded in the mouth cavity and are reattached on the model for upper and lower-jaw work. After the wax dentures are produced in the upper jaw and lower jaw base floors attached on the model for upper and lower-jaw work by a dental mechanic, a dentist attaches the wax dentures to the mouth cavity of the patient to confirm tooth arrangement, occluding, jaw positions and the like. After that, final dentures are produced by a dental mechanic.

According to the tool disclosed in Patent Literature 1, a patient can easily sense feelings of the occluding state at the bite taking to determine an optimal lower jaw position easily.

In addition, the bite taking rim according to Non-Patent Literature 1 can acquire a predetermined jaw-jaw relation at tapping by the metallic tool with three connected hemispheres put on the wax rim of the lower jaw. Therefore, the bite taking rim has advantages of being capable of achieving the bite taking without using the bite taking material, easily acquiring registration of paraffin wax, easily acquiring tapping points, easily checking functional movements, and the like.

### CITATION LIST

### Patent Literature

Patent Literature 1
Japanese Patent Application Laid-Open No. 2005-152106

### Non-Patent Literature

Non-Patent Literature 1
“Lingualized Occlusion—Occlusion of Dentures/Occlusion of Implant—” by the supervising editors: Naoyuki Matsumoto, Tetsuo Ichikawa, Ishiyaku Publishers, Inc., 2010, p. 40.

### SUMMARY OF INVENTION

### Technical Problem

However, even if the tool disclosed in Patent Literature 1 or the like is used, in a case where skills of an operator are scarce, the alignment of the low jaw cannot be appropriately performed, and in some cases at the time of attaching the wax dentures into the mouth cavity of a patient, the wax dentures are not adapted for the patient. In that case, it is required to perform the bite taking once more, unfortunately making the time required for the whole process of the complete denture production longer.

Since the tool disclosed in Non-Patent Literature 1 has a portion that comes in contact with the metallic hemisphere and is formed of a wax rim made up of a paraffin wax, the jaw position is possibly guided by impressions formed on the occlusal flat surface. Particularly in a case of a patient having the unstable jaw position, there occurs a problem that the tapping point is not converged, and the jaw position is easily guided by the first formed impressions. Since the tool is large in the dentition direction, there is posed a problem that the tool is used only for a patient whose jaw is small or a case where a molar is completely lost.

The present invention has an object of providing a tool for 3D adjustment of a muscle position that can perform alignment of a lower jaw with good accuracy despite skills and experiences of an operator and can shorten a time required for a whole process of denture production. Further, the present invention has an object of providing a tool applicable also to medical treatment for adjustment of a jaw position such as sprint medical treatment. In addition, the present invention has an object of providing an articulator appropriate for performing 3D adjustment of a muscle position and performing alignment of a lower jaw.

### Solution to Problem

For achieving the above objects, a first embodiment relates to a tool for 3D adjustment of a muscle position to match a centric position and a centric occlusal position of a patient having lost a jaw position comprising a first member to be attached in a position corresponding to left and right molar regions, and a second member to be attached in a position opposing the first member, the first member being provided with a plurality of convex parts on a surface facing the second member, the convex parts having distal ends capable of sliding on an upper surface of the second member, and the second member being formed in such a manner that a surface facing the first member is a substantially flat surface (first invention).

In the tool for 3D adjustment of the muscle position according to the first invention, the second member is, for bite taking, first attached in a position corresponding to the left and right molar regions to align with an occlusion flat surface preliminarily defined from states of a lower jaw and an upper jaw of the patient. The second member may be attached to either of the upper jaw or the lower jaw, and herein an explanation will be made primarily of an example where the second member is attached to the lower jaw side. Next, the first member having the convex part is attached in such a manner that, when an occlusal movement is performed in a mouth cavity of the patient, the convex part of the first member abuts on the substantially flat second member.

Subsequently, the occlusal movement is performed. It is confirmed whether the distal end of the convex part abuts and slides on the second member following the occlusal movement. At this time, use of the occlusal rim (wax rim) of a standard model does not cause needs of adjustment in the height direction so much, but in a case where the height adjustment is needed depending upon a patient, the adjustment of the upper/lower position is performed. The adjustment of the upper/lower position is, when the tool for 3D adjustment of the muscle position itself is provided with adjustment of height function, performed by adjusting a height of the tool itself. When the adjustment function in height is not provided, it may be performed by adjustment of a height of the occlusal rim.

As a result, in a state where the distal ends of the left and right convex parts abut on the second member, one flat surface is defined by four or more abutting positions, and the lower jaw position to the upper jaw can be determined assuming this flat surface as an occlusal flat surface. The determined lower jaw position to the upper jaw can be recorded by an abutting position between the distal ends of the convex parts and the substantially flat second member.

According to the tool for 3D adjustment of the muscle position in the first invention, since a contact area at the time the distal ends of the convex parts of the first member abut on the second member is smaller than in a case where the distal end surface of the marking blade abuts on the recording block, the alignment of the lower jaw can be performed with good accuracy despite the skills of the operator or the like.

For the stable position of the condyle of a jaw joint, it is required to perform adjustment by applying vibrations to the lower jaw bone in a state where a guide surface does not exist on an occlusal surface with which upper and lower dentition arches come in contact. Particularly, in a case a patient is loose in a jaw joint, a slight inclination is the cause for non-match between the centric position and the centric occlusal position. Therefore, it becomes very advantageous that one member is formed of a flat plate. Accordingly, the present tool for 3D adjustment of the muscle position has the advantage of being capable of being guided to the centric position (stable position of the condyle) with more accuracy as compared to the bite taking rim and by placing the position to the centric occlusal position (maximal fitting position), it is possible to accurately achieve the match between the centric position and the centric occlusal position, the complete match of which has ever been thought to be impossible.

According to the tool for 3D adjustment of the muscle position in the first invention, it is possible to perform the alignment of the lower jaw at bite taking with good accuracy and it becomes unnecessary to perform the bite taking again. Therefore, the time required for the whole process of the complete denture production can be shortened.

According to the tool for 3D adjustment of the muscle position in the first invention, a shape of the convex parts of the first member is characterized by being a shape in imitation of the condyle of a patient (second invention).

The first member in the second invention is formed of a plate-shaped member on which a plurality of convex parts are formed, the convex parts having a shape approximate to the condyle of a patient. The shape of the condyle differs for each patient, and even for the same patient, there are some cases where shapes of the left and right condyles differ. A picture of the shape of the condyle of a patient is preliminarily taken by X-ray for confirmation. As the first member, there is prepared a member provided with a convex part matched to a representative shape of condyle of several kinds to be capable of selecting the shape of the condyle to adjust to the state of the condyle of the patient.

The tool for 3D adjustment of the muscle position in the present embodiment can guide the jaw joint to the stable position of the condyle by using a convex part of a shape approximate to the condyle to the first member. By selecting the convex part approximate to the shape of the condyle of the patient, the centric position and the centric occlusal position can be matched with good accuracy for each patient.

The tool for 3D adjustment of the muscle position is characterized in that the first member and the second member each include a plurality of sharp parts capable of being inserted in the occlusal rim, and are attached by inserting the sharp parts in the occlusal rim (third invention).

The tool for 3D adjustment of the muscle position in the third invention, for performing the bite taking, first, attaches the occlusal rim to a patient and attaches a pair of second members to a position corresponding to left and right molar regions to oppose a portion substantially flatly formed in a lower jaw occlusal rim to an upper jaw. The second member has an upper surface facing the upper jaw, the upper surface being formed in a flat plate shape, and includes a sharp part projecting downward substantially vertically from the flat-plate-shaped member. The sharp part enables the second member to be stuck into an occlusal rim produced with a wax material. Since the second member can be attached in the mouth cavity of a patient, the second member can be attached in an appropriate position by any operator.

Next, the first member is attached to a position of the upper jaw occlusal rim opposing the second member in such a manner that the convex part of the first member abuts on the second member when the occlusal movement is performed. The attachment of the first member is performed by sticking the sharp part into the occlusal rim as similar to the second member. Since the positional adjustment in the horizontal direction is already visually performed at the attaching time of the first member, a distance between the convex part of the first member and the second member, that is, a height of the upper jaw occlusal rim and lower jaw occlusal rim in the upper-lower direction is adjusted. At this time, when a wax rim of a standard model is used, the adjustment in the height direction is not required so much, but in a case where the height adjustment is required depending upon a patient, as usually performed in a case of the denture production, the adjustment of the upper-lower position is performed by cutting the wax rim or melting the wax rim to be lowered in height, or adding paraffin wax.

When the tool for 3D adjustment of the muscle position in the present embodiment is applied, the first member provided with the convex parts in a shape approximate to the condyle of a patient or the first member provided with spherical and hemispherical convex parts in a size determined to be appropriate based upon the body size of a patient is preliminarily selected and is easily attached by being stuck into the occlusal rim, thus making it possible to match the centric position and the centric occlusal position of the patient for a short time.

The tool for 3D adjustment of the muscle position is characterized in that the first member and the second member each include an adhesive part capable of adhering to the occlusal rim and adhere to the occlusal rim by the adhesive part (fourth invention).

The tool for 3D adjustment of the muscle position in the fourth invention includes the adhesive part instead of the sharp part in the third invention. The adhesive part is produced by preliminarily applying an adhesive tape such as a double-faced tape to the first member and the second member.

For performing the bite taking, first, after the occlusal rim is attached to a patient, a pair of the second members are attached by adhesive parts to the position corresponding to the left and right molar regions, with the adhesive parts of a pair of the second members being directed to the lower jaw occlusal rim. Since the second member can be easily attached in the mouth cavity of a patient, the second member can be attached to an appropriate position by any operator.

Next, the first member adheres to the occlusal rim in a position of the upper jaw occlusal rim opposing the second member by the adhesive part as similar to the second member in such a manner that the convex part of the first member abuts on the second member when the occlusal movement is performed. Since the first member and the second member both can be attached to the occlusal rim by the adhesive part, the first member and the second member can be attached in the appropriate position.

The tool for 3D adjustment of the muscle position in the present embodiment is characterized in that the second member is formed in a sprint shape covering the whole dentition (fifth invention).

The second member in the tool for 3D adjustment of the muscle position in the present embodiment may be formed in the sprint shape. With the sprint shape, it is also possible to perform medical treatment of a patient having the need of matching the centric position and the centric occlusal position, such as jaw arthritis. There are many cases where so-called sprint medical treatment is performed to address a situation of occurrence of a trouble in a jaw joint and slippage in an articular disc. As a result, the movement of the jaw is limited or the occluding changes, possibly causing troubles in a daily life. In a case of matching the centric position and the centric occlusal position by the medical treatment to such a patient, the sprint medical treatment is considered to be effective.

However, in a regular sprint medical treatment, a dentist performs occlusal adjustment of the sprint in surface contact in the upper and lower side in the mouth cavity, but it is difficult to perform the occlusal adjustment of predicting a complicate chewing cycle or sleep bruxism as well to accurately delete interference. In the tool for 3D adjustment of the muscle position in the present embodiment, a contact surface of one of the upper and lower sprints has a regular sprint shape of a substantially flat surface and convex parts are formed on only upper and lower required contact points of the other sprint. As a result, the portions other than the contact points can be set to be low, and the interference is not caused even in the complicate chewing cycle or at the sleep bruxism, making it possible to acquire a high medical treatment effect.

Further, an articulator for 3D adjustment of a muscle position in the present embodiment is characterized by including an upper arch part for supporting a upper jaw model, and a lower arch part for supporting a lower jaw model, the upper arch part including an upper arch member and an upper arch support, the lower arch part including a lower arch member and a lower arch support, the upper arch support including an upper arch support horizontal part configuring an upper arch part adhered to the upper arch member and an upper arch support vertical part descending vertically in the upper arch member front, the lower arch support including a lower arch support horizontal part configuring a lower arch part adhered to the lower arch member and a lower arch support upward part extending toward the upper arch part backward, the upper arch part being provided in the backward side with a condylar part composed of a condylar convex part and a condylar receiver in the left and right respectively, the lower arch part being provided at the front lower part with an auxiliary condylar part composed of an auxiliary condylar convex part and an auxiliary condylar receiver, the condylar convex parts each being capable of sliding relative to the condylar receiver corresponding thereto, and the auxiliary condylar convex parts each being capable of sliding relative to the auxiliary condylar receiver corresponding thereto (sixth invention).

The articulator for 3D adjustment of the muscle position in the present embodiment includes the condylar part and the auxiliary condylar part. Therefore, the upper arch part and the lower arch part can move relative to each other. As a result, it is possible to easily perform the denture production in which the centric position corresponds to the centric occlusal position.

Further, the articulator for 3D adjustment of the muscle position in the present embodiment is characterized in that the condylar parts are disposed in the left and right one by one, the condylar part is formed of a condylar convex part or a condylar receiver in a distal end of the lower arch support upward part, and a condylar receiver or a condylar convex part in the backward side of the upper arch part, and when the condylar convex part is disposed in the distal end of the lower arch support upward part, the condylar receiver is disposed in the backward side of the upper arch part, and when the condylar receiver is disposed in the distal end of the lower arch support upward part, the condylar convex part is disposed in the backward side of the upper arch part, and the auxiliary condylar parts are disposed, one in the center of the lower arch part or in the left and right one by one, the auxiliary condylar part is formed of an auxiliary condylar convex part or an auxiliary condylar receiver in a lower end of the upper arch support vertical part, and an auxiliary condylar receiver or an auxiliary condylar convex part in the forward side of the lower arch part, and when the auxiliary condylar convex part is disposed in the lower end of the upper arch support vertical part, the auxiliary condylar receiver is disposed in the forward side of the lower arch part, and when the auxiliary condylar receiver is disposed in the lower end of the upper arch support vertical part, the auxiliary condylar convex part is disposed in the forward side of the lower arch part (seventh invention).

The upper arch support horizontal part of the upper arch support adheres along both ends of the upper arch part in the left and right, but the upper arch support vertical part may be formed of a pair of left and right members, the left and right members descending vertically as continuous members from the left and right upper arch support horizontal parts or may be formed as a member different from the upper arch support horizontal part, the member being one member descending vertically from the front center of the upper arch part. That is, the articulator for 3D adjustment of the muscle position is provided with the pair of the left and right condylar parts, and the one auxiliary condylar part in the center or the pair of the left and right auxiliary condylar parts.

The articulator in the present embodiment is configured such that the upper arch part and the lower arch part are relatively capable of sliding by a total of three or four movable parts composed of the left and right condylar parts positioned in the backward side of the upper arch part and the auxiliary condylar parts, one positioned in the center part or two positioned in the left and right of the lower arch part front. Therefore, since the movement of the lower jaw can be imitated, it is possible to more easily adjust a relative position between the upper arch part and the lower arch part and produce the denture in such a manner as to cause the centric position to correspond to the centric occlusal position.

In addition, the articulator for 3D adjustment of the muscle position in the present embodiment is characterized in that the condylar convex part or the auxiliary condylar convex part is formed in a shape in imitation of a condyle of a patient, and the condylar receiver or the auxiliary condylar receiver has a surface opposing the condylar convex part or the auxiliary condylar receiver, the surface being formed in a substantially flat surface or in a shape in imitation of a glenoid cavity of a patient (eighth invention).

The surface, which opposes the condylar convex part, of the condylar receiver may be the substantially flat surface or formed in the shape in imitation of the glenoid cavity, but more preferably the substantially flat surface. With formation of the substantially flat surface, a guide surface is not present on the occlusal surface, thus making it possible to guide the jaw joint to the stable position of the condyle.

It has been clear for the shape of the condyle of a patient to vary variously due to a pathological change or aging. By using the shape in imitation of the condyle of a patient, such as a doom shape, a tapered shape with a sharp end, and a shape with unevenness, it is possible to cause the centric position to correspond to the centric condylar position with good accuracy.

In addition, the articulator for 3D adjustment of the muscle position in the present embodiment is characterized by including a lip sheet arranging part configured to arrange a lip sheet of a patient (ninth invention).

When a picture of a shape of lips of a patient is arranged, it is possible to arrange dentures adapted for the shape of the lips of the patient. As a result, a time for denture production can be shortened.

### BRIEF DESCRIPTION OF DRAWINGS

FIG. 1A is a perspective view of a tool for 3D adjustment of a muscle position according to a first embodiment.

FIG. 1B is a perspective view illustrating a use state of the tool for 3D adjustment of the muscle position illustrated in FIG. 1A.

FIG. 2A is a view illustrating a 3D sheet of anterior tooth provisional arrangement.

FIG. 2B is a perspective view illustrating a use state where the 3D sheet of anterior tooth provisional arrangement is attached to the tool for 3D adjustment of the muscle position illustrated in FIG. 1A.

FIG. 3A is a perspective view of a tool for 3D adjustment of a muscle position according to a second embodiment.

FIG. 3B is a perspective view illustrating a use state of the tool for 3D adjustment of the muscle position illustrated in FIG. 3A.

FIG. 3C is a perspective view illustrating a use state where a 3D sheet of anterior tooth provisional arrangement is attached to the tool for 3D adjustment of the muscle position illustrated in FIG. 3A.

FIG. 4A is a perspective view and a side view of a tool for 3D adjustment of a muscle position according to a third embodiment.

FIG. 4B is a perspective view illustrating a use state of the tool for 3D adjustment of the muscle position illustrated in FIG. 4A.

FIG. 5A is a perspective view of a fourth embodiment.

FIG. 5B is a view illustrating a variation of the fourth embodiment.

FIG. 5C is a view illustrating a variation of the fourth embodiment.

FIG. 5D is a view illustrating a variation of the fourth embodiment.

FIG. 6A is a view of a fifth embodiment.

FIG. 6B is a view illustrating a variation of the fifth embodiment.

FIG. 6C is a view illustrating a variation of the fifth embodiment.

FIG. 6D is a view illustrating a variation of the fifth embodiment.

FIG. 6E is a view illustrating a variation of the fifth embodiment.

FIG. 7 is a view illustrating an artificial tooth in a trial application of a muscle position.

FIG. 8 is a view illustrating the artificial tooth in the trial application of the muscle position one side of which is formed in a sprint shape.

FIG. 9A is a view illustrating a variation of the artificial tooth in the trial application of the muscle position.

FIG. 9B is a view illustrating a variation of the artificial tooth in the trial application of the muscle position.

FIG. 10A is a perspective view of an articulator for 3D adjustment of a muscle position.

FIG. 10B is a cross sectional view of a front condylar part in the articulator for 3D adjustment of the muscle position.

FIG. 11 is a view where a lip sheet is arranged in the articulator for 3D adjustment of the muscle position.

### DESCRIPTION OF EMBODIMENTS

Hereinafter, descriptions will be made primarily of a complete denture medical treatment, but without mentioning, the present invention is applicable to medical treatment of a patient with partially remaining anterior teeth or the like, further a sprint medical treatment in jaw joint medical treatment and other disease such as malocclusion.

### Embodiment 1

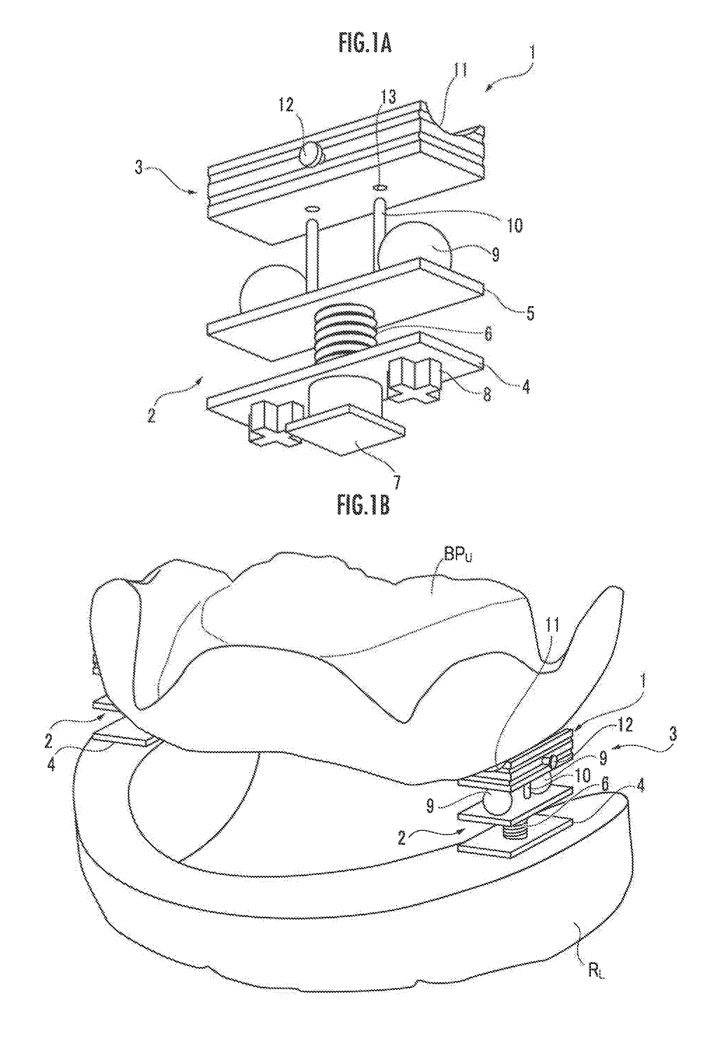

Embodiments will be in more detail described with reference to the accompanying drawings. First, an explanation will be made of a tool 1 for 3D adjustment of a muscle position as a first embodiment illustrated in FIG. 1A. The tool 1 for 3D adjustment of the muscle position is provided with a pair of first members 2 adhered to left and right molar regions of a lower jaw occlusal rim R_{L} applied to a lower jaw base floor (unillustrated), and a pair of second members 3 finally adhered to portions, which oppose the first members 2, of an upper jaw base floor BP_{U} (refer to FIG. 1B). The first member 2 and the second member 3 are made of resin such as composite resin or acryl resin.

The tools 1 for 3D adjustment of a muscle position in the present embodiment variously modified in size to be fit to a size of a body framework are prepared. Hereinafter, the tool 1 is sized to be fit to a patient of a standard body framework as reference, but even if a tool having a size different from this size is applied, the tool sized to be fit to the body framework of a patient can be produced. The first member 2 has a length corresponding to a length from a first premolar tooth to a first molar tooth of a lower jaw. The first member 2 includes two plate-shaped members composed of an installation member 4 having a thickness of 1.0 to 2.0 mm and a first plate-shaped member 5 having a thickness of 0.5 to 5.0 mm.

A screw member 6 having a pitch of 0.25 to 1.25 mm is disposed in the lower center of the first plate-shaped member 5. When the screw member 6 goes through a hole formed in the central part of the installation member 4 and is screwed into a receiver 7 with a screw groove formed in the center, a distance between the first plate-shaped member 5 and the installation member 4 is adjusted and the first plate-shaped member 5 and the installation member 4 are configured to be capable of engaging.

The installation member 4 is provided with disengagement preventive members 8 at the lower side to easily entangle silicon impression materials and paraffin wax when installed on the occlusal rim and prevent disengagement from the occlusal rim. The disengagement preventive member 8 is here a projection having a cross shape in section, but a disengagement preventive member of any shape may be also used as long as the disengagement from the occlusal rim can be prevented with a surface area increased.

In addition, the first plate-shaped member 5 is provided with two convex parts 9 on a surface facing the second member 3, the convex part having one apex, such as a sphere having a diameter of 1.0 to 20.0 mm, preferably 1.0 to 5.0 mm or a doom having the same height. The first plate-shaped member 5 is provided with two positioning members 10 between the convex parts 9. The positioning members 10 are broken and removed after the positions of the first member 2 and the second member 3 are determined. Therefore, the positioning member 10 is a bar-shaped member of a diameter to be easily broken or is configured to be easily broken and removed by forming grooves or the like on a root end.

The second member 3 installed on the base floor of the upper jaw has a length equivalent to that of the first member 2 having a thickness of 1.0 to 22.0 mm, preferably 3.0 to 5.0 mm and a side face having one to six grooves, the groove having approximately 0.3 to 2.0 mm. These grooves can prevent the second member 3 from being disengaged from the occlusal floor. A U letter-shaped pocket 11 is disposed on a surface in contact with a base floor close to the center in the length direction (dentition direction). For adhesion of the second member 3 to the base floor, the working can be easily performed by using the U letter-shaped pocket 11 for introduction of quick cure resin. An engaging projection 12 is disposed on a cheek lateral face for engaging 3D sheet of the anterior tooth provisional arrangement. Two positioning holes 13 going through the second member 3 in the thickness direction are disposed near the center of the second member 3 in the length direction (dentition direction) in a position and in a shape corresponding to the positioning member 10 of the first member 2. The second member 3 adheres to the base floor in such a manner that the positioning member 10 of the first member is fitted into the positioning hole 13.

The second member 3 in the present embodiment has a surface formed as a substantially flat surface, the surface facing the first member 2, and, when the convex part 9 is caused to abut on the second member 3 in the mouth cavity and is moved in a horizontal direction, a distal end of the convex part 9 is configured to be capable of sliding on the second member 3. Since a surface, which is in contact with the convex part 9 of the first member 2, of the second member 3 is formed to be flat, it is possible to cause the centric position to correspond to the centric occlusal position with good accuracy.

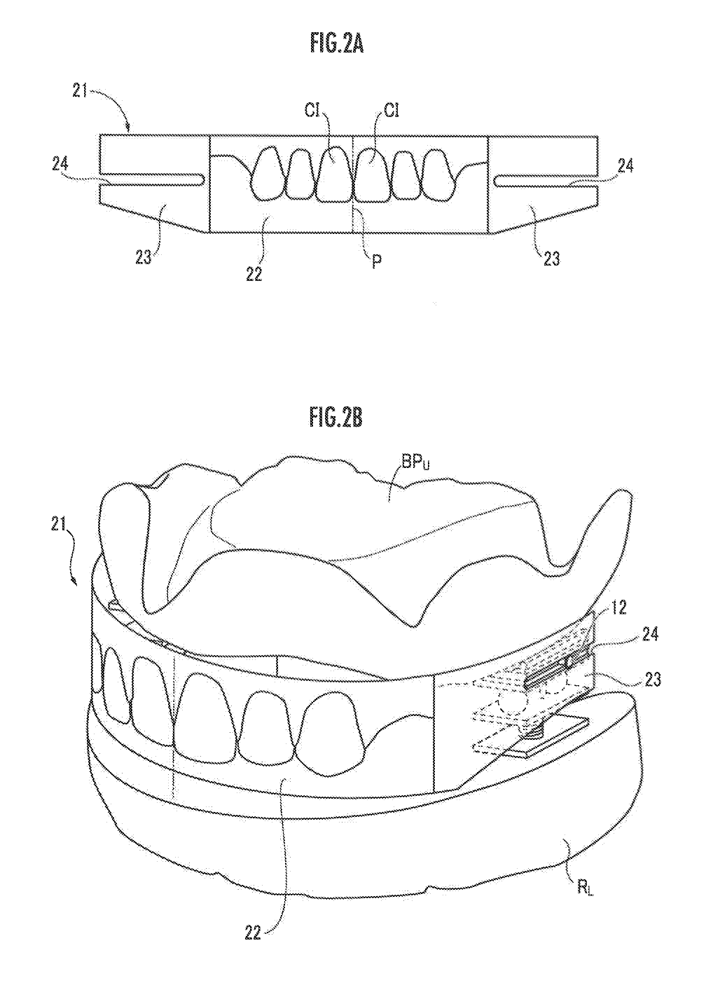

Next, an explanation will be made of a use method of the tool 1 for 3D adjustment of the muscle position with reference to FIG. 1A to FIG. 2B. For performing the bite taking, first, the lower jaw occlusal rim R_{L} is applied on the lower jaw base floor by a dental mechanic and the pair of the first members 2 adhere to a portion of the lower jaw occlusal rim R_{L} corresponding from the first premolar tooth to the first molar tooth by a wax material such as paraffin wax. At the adhesion, the screw member 6 continues to be screwed into the receiver 7 until it is fully received therein, and therefore the height adjustment can be easily performed thereafter. A lower surface of the first plate-shaped member 5 is caused to adhere to be substantially equal in height to the lower jaw occlusal rim R_{L}.

Next, the lower jaw base floor in which the first member 2 adheres to the lower jaw occlusal rim R_{L} and the upper jaw base floor BP_{U} to which the upper jaw occlusal rim R_{U} is not applied are attached in the mouth cavity of a patient by a dentist.

Next, the second members 3 adhere to positions of the upper jaw base floor BP_{U} opposing the left and right first members 2 (that is, a portion corresponding from the first premolar tooth to the first molar tooth) in such a manner that the distal end of the convex part 9 of the first member 2 abuts on the second member 3 when the occlusal movement is performed. At this time, the positioning member 10 of the first member 2 is inserted in the positioning hole 13 of the second member 3 for fixation. After the fixation, the positioning members 10 are broken and removed to perform the occlusal movement.

Next, a distance between the second member 3 and the convex part 9, that is, the height of the lower jaw occlusal rim R_{L} to the upper jaw base floor BP_{U} in the upper-lower direction is adjusted. The height adjustment in the upper-lower direction is performed by rotating the first plate-shaped member 5 to the installation member 4 and approaching the first plate-shaped member 5 to the installation member 4 or retreating the first plate-shaped member 5 from the installation member 4 in a half pitch unit of the screw member 6 to perform the adjustment in such a manner that the whole height is not too high or too low and the left and right are equally contacted. Accordingly, the height adjustment can be performed more easily and more quickly as compared to a case of grinding the recording block or adding the resin.

Next, the occlusal movement is performed, and at this time, the distal end of the spherical convex part 9 slides on the second member 3. The tapping movement is performed, and the check bite is performed for registration. As a result, one occlusal flat surface is defined in a state where the distal ends of the four convex parts 9 abut on the second member 3 all together in the left and right. This flat surface is assumed as the occlusal flat surface, making it possible to determine the lower jaw position to the upper jaw. The determined lower jaw position to the upper jaw can be recorded by an abutting position between the distal end of the convex part 9 and the second member 3. At this time, since the second member 3 is the flat surface, it is possible to guide the jaw joint to the stable position of the condyle in a state where the guide surface does not exist on the occlusal surface with which the upper and lower dentition arches are in contact.

The present embodiment shows the example in which the first member 2 provided with the convex part 9 is installed in the lower jaw side and the second member 3 is installed in the upper jaw side, but the occlusal surface may be determined by using the convex part 9 and the flat member, and the first member 2 may be arranged in the upper jaw side and the second member 3 may be arranged in the lower jaw side.

After the lower jaw position to the upper jaw is determined, the dentition position is subsequently determined. Next, an explanation will be made of a use method of a 3D sheet 21 of anterior tooth provisional arrangement with reference to FIG. 2A and FIG. 2B.

When respective engaging parts 24 of respective extension parts 23 in the 3D sheet 21 of anterior tooth provisional arrangement illustrated in FIG. 2A, are engaged to the respective engaging projections 12 disposed in the second member 3, the 3D sheet 21 of anterior tooth provisional arrangement is attached to the tool 1 for 3D adjustment of the muscle position in the first embodiment. At this time, the 3D sheet 21 of anterior tooth provisional arrangement in which arrangement of the upper anterior teeth of a display part 22 of upper tooth arrangement is adapted for a patient is selected.

Subsequently, the 3D sheet 21 of anterior tooth provisional arrangement is moved in the dentition direction along the slit-shaped engaging part 24, and a center line P between upper jaw cutting teeth C1, C1 of the display part 22 of upper tooth arrangement is positioned on median palatine raphes and an extension line of superior labial frenulum of a patient to perform alignment of the upper denture. Since the engaging part 24 is formed in a slit shape, the 3D sheet 21 of anterior tooth provisional arrangement is caused to be movable in the left and right. Therefore, it is possible to perform the alignment of the upper denture easily.

Thereby the outer appearance at the time the dentures are attached on a patient is confirmed by the 3D sheet 21 of anterior tooth provisional arrangement engaged to the engaging projection 12, making it possible to record a position of the dentition preferable for the lower jaw occlusal rim R_{L} and the upper jaw base floor BP_{U}.

Here, the 3D sheet 21 of anterior tooth provisional arrangement provided with the engaging part 24 is used, but a 3D seal of anterior tooth provisional arrangement in a seal shape that is provided with a display part of upper tooth arrangement and the backside of which is a glue surface may be used. In a case of using the 3D seal of anterior tooth provisional arrangement, the center line P between upper jaw cutting teeth C1, C1 printed on the surface is positioned on median palatine raphes and an extension line of superior labial frenulum of a patient, the 3D seal of anterior tooth provisional arrangement adheres to the upper jaw base floor BP_{U} by the glue surface, and the alignment of the upper dentures may be performed.

After the bite taking is performed in the mouth cavity of a patient as described above, the tool 1 for 3D adjustment of the muscle position is taken out of the mouth cavity in a state of adhering to the lower jaw occlusal rim R_{L} and the upper jaw base floor BP_{U}. After that, the upper and lower jaw working model is attached and fixed on the articulator by a dental mechanic. The articulator generally used may be used, but when an articulator suitable for 3D adjustment of a muscle position to be described later is used, it is possible to perform the alignment of the lower jaw with better accuracy.

### Embodiment 2

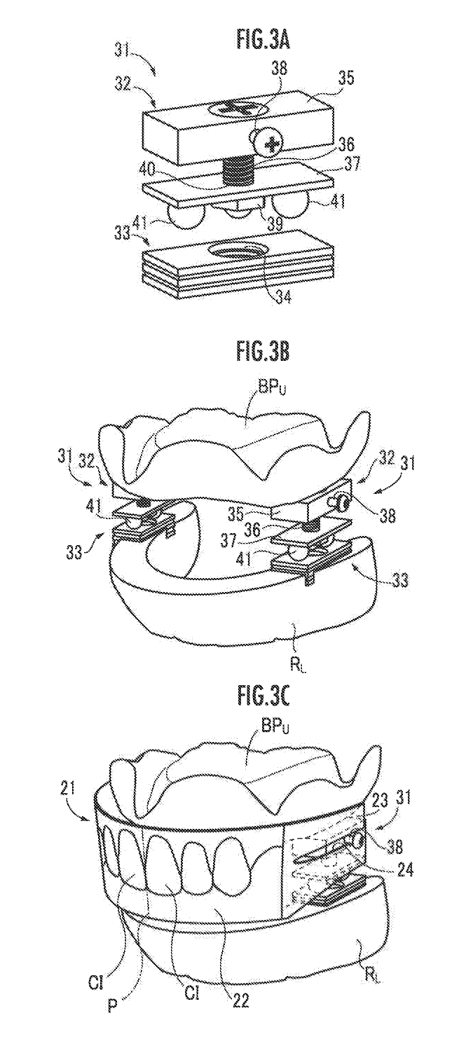

Next, an explanation will be made of a tool 31 for 3D adjustment of a muscle position in a second embodiment. As illustrated in FIG. 3A, the tool 31 for 3D adjustment of the muscle position includes a first member 32 having a convex structure and a second member 33 having a substantially flat upper surface. The tool 31 for 3D adjustment of the muscle position is provided with a pair of second members 33 adhered to left and right molar regions of a lower jaw occlusal rim R_{L} applied to a lower jaw base floor (unillustrated), and a pair of first members 32 adhered to portions, which oppose the second members 33, of an upper jaw base floor BP_{U} (refer to FIG. 3B). The first member 32 and the second member 33 are made of resin such as acryl resin as similar to the tool in the first embodiment. The first member 32 and the second member 33 for a patient of a standard body framework will be hereinafter explained.

The second member 33 has a length corresponding to a length from a first premolar tooth to a first molar tooth of a lower jaw and has a thickness of 1.0 to 22.0 mm, preferably 1.0 to 6.0 mm. The second member 33 has a side face having one to six grooves, the groove having a thickness of approximately 0.3 to 2.0 mm. These grooves cause silicon impression materials and paraffin wax to be easily entangled, preventing the second member 33 from being disengaged from the occlusal floor. The second member 33 is formed to be flat except that a round hole 34 is disposed in the central part of the second member 33 in the length direction (dentition direction) to penetrate through the second member 33 in the thickness direction.

The first member 32 has a length equivalent to that of the second member 33, and includes a base 35 having a thickness of 3.0 to 5.0 mm, a screw member 36 having a pitch of 0.25 to 1.25 mm that penetrates through the base 35 in the thickness direction to project toward the first member 32 from the central part of a surface of the base 35 facing the second member 33, and a first plate-shaped member 37 having a length corresponding to the base 35 and having a thickness of 0.5 to 5.0 mm, preferably 1.0 to 2.0 mm.

The base 35 has a lateral face (refer to FIG. 3B) facing cheek mucosa at the time of being attached in the mouth cavity, a small screw being threaded on the lateral face, and an engaging projection 38 projecting outward is formed of the small screw.

A through hole 40 communicated with a nut hole (unillustrated) of a nut 39 is disposed on the central part of a surface of the first plate-shaped member 37 facing the second member 33 in the length direction (dentition direction). The first plate-shaped member 37 is screwed through the nut hole and the through hole 40 by a screw member 36 and is configured to be movable in the height direction.

In addition, the first plate-shaped member 37 is provided with two convex parts 41 in both sides of the nut 39 on a surface facing the second member 33, the convex part 41 having one apex, such as a sphere having a diameter of 1.0 to 20.0 mm, preferably 1.0 to 5.0 mm or a doom having the same height. The two convex parts 41 are disposed in the same distance from the nut 39. The convex part 41 is capable of abutting on a flat face of an upper surface of the second member 33, and further, when the second member 33 is moved horizontally to the first plate-shaped member 37, a distal end of the convex part 41 is capable of sliding on the upper surface of the second member 33.

In a case of performing the height adjustment of the occlusal surface, as similar to the first embodiment, the height adjustment is performed by rotating the first plate-shaped member 37 to the second member 33 and causing the first plate-shaped member 37 to approach to the second member 33 or causing the first plate-shaped member 37 to retreat from the second member 33 in a half pitch unit of the screw member 36. After the lower jaw position to the upper jaw is determined, as similar to the first embodiment, the 3D sheet 21 of the anterior tooth provisional arrangement is used to record an optimal position of the dentition (refer to FIG. 3C).

Here, an explanation is made of a case where the second member 33 is installed in the lower jaw side and the first member 32 is installed in the upper jaw, but the adjustment of the jaw position may be performed by the installing to an upside down. Also, in a case of the installing to an upside down, the use method is basically executed in the same way.

### Embodiment 3

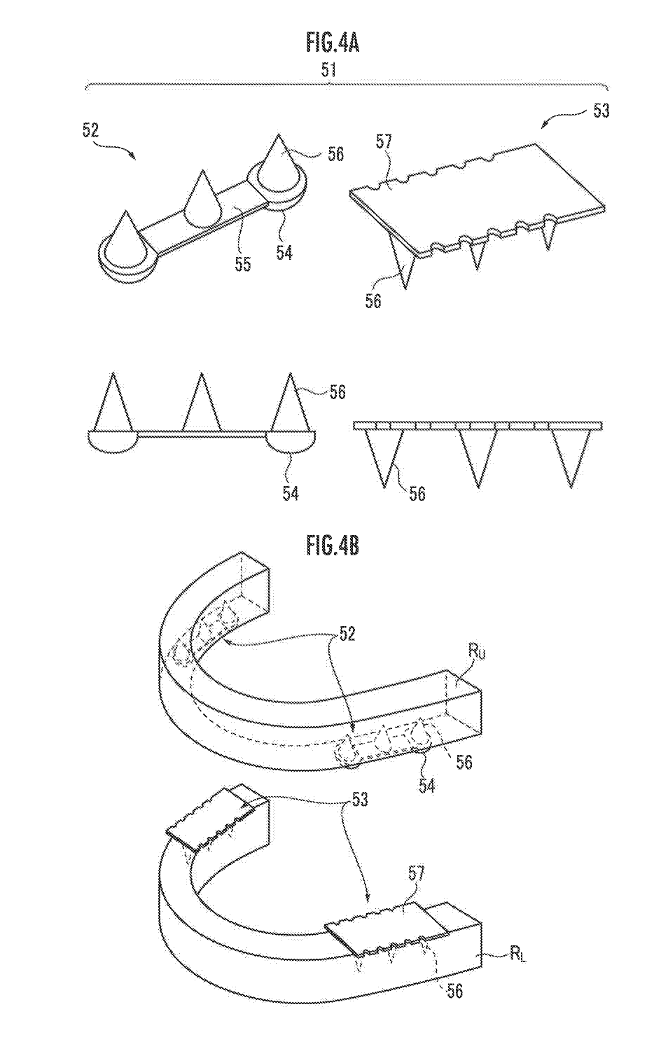

Next, an explanation will be made of a tool 51 for 3D adjustment of a muscle position in a third embodiment. The tool 51 for 3D adjustment of the muscle position in a third embodiment includes a first member 52 and a second member 53. FIG. 4A illustrates a perspective view of the first member 52 and the second member 53 in the upper side and a side view of the first member 52 and the second member 53 in the lower side.

The first member 52 includes two convex parts 54, a connecting member 55 connecting the convex parts 54, and a plurality of sharp parts 56 disposed on a surface at the opposite side to the convex parts 54. The first member 52 has a length (dentition direction) of 5.0 to 55.0 mm and a width of 1.0 to 25.0 mm and is provided with the convex parts 54. The convex part 54 may be formed in a doom shape, in a spherical shape or in a shape in imitation of the condyle of a patient, and a height from the connecting member 55 is in a range of 0.5 to 20.0 mm. It is preferable for the first member 52 to be formed in a condylar shape in terms of adjustment of the jaw position. The first members 52 having convex parts of a plurality of shapes and heights are prepared to be capable of selecting members approximate to the shape of the condyle of a patient. The shape of the condyle of a patient is preliminarily acquired by an X-ray picture or the like, thus making it possible to select the first member 52 having the convex part approximate to the condyle of a patient. The adjustment of the jaw position can be performed with more accuracy using the tool for 3D adjustment of the muscle position approximate to the condyle of a patient. In addition, the convex parts 54 differ in height at an interval equal to or less than 2 mm are prepared, thereby making it possible to use the tool suitable for each of various patients. Further, herein the first member provided with the two convex parts 54 is described, but the number of the convex part may be one, and two or more of the convex parts may be provided.

The connecting member 55 connects the convex parts 54 and arranges the convex parts 54 on the wax rim. Here, the connecting member 55 has a shape narrower in width than the convex part 54 but may be a member having a shape to arrange a plurality of convex parts on a plate-shaped member. The sharp part 56 is disposed on the backside of the convex part 54 or on the connecting member 55 and on a surface at the opposite to the surface on which the convex part 54 is disposed and is formed substantially vertically to the connecting member 55. When the sharp part 56 is sized to have a height of 1.0 to 22.0 mm, it is possible to easily arrange the sharp part 56 on the wax rim. The second member includes a plate-shaped second plate-shaped member 57 having a length of 5.0 to 65.0 mm, a width of 1.0 to 25.0 mm and a thickness of 1.0 to 20.0 mm, and the sharp parts 56.

The tool 51 for 3D adjustment of the muscle position in the third embodiment attaches the pair of the second members 53 in positions corresponding to the left and right molar regions in the lower jaw of a patient after attaching the occlusal rim to the patient (refer to FIG. 4B). At this time, the second member 53 is attached in such a manner that the second plate-shaped member 57 is flush with the occlusal flat surface of the patient. The attachment is performed by sticking the sharp parts 56 in the occlusal rim. A slit may be formed on the side face of the second plate-shaped member 57 to cause silicon impression materials and paraffin wax to be easily entangled.

Next, the first member 52 is attached in such a manner that the convex part 54 causes the first member 52 having the convex parts 54 to abut on the second plate-shaped member 57 when the occlusal movement is performed in the mouth cavity of a patient. The attachment of the first member 52 as well is performed by sticking the sharp parts 56 in the occlusal rim.

Subsequently the occlusal movement is performed, and it is confirmed whether a distal end of the convex part 54 abuts and slides on the second plate-shaped member 57 following the occlusal movement. At this time, when an occlusal rim (wax rim) of a standard model is used, the adjustment in the height direction is not required so much. In a case where the height adjustment is required depending upon a patient, the adjustment of the upper-lower position is, as usually performed in a case of denture production, performed by grinding or melting the wax rim to lower the height, or adding paraffin wax. As a result, in a state where the distal ends of the left and right convex parts 54 abut on the second plate-shaped member 57, one flat surface is defined by three abutting positions. This flat surface is assumed as the occlusal flat surface, making it possible to determine the low jaw position to the upper jaw. Here, the explanation has been made using the member with the four convex parts, two for each in the left and right, but approximately one to six convex parts may be provided for each side. After the completion of the adjustment of the jaw position, the occlusal rim is taken out and the dentures may be produced as similar to the regular denture production.

### Embodiment 4

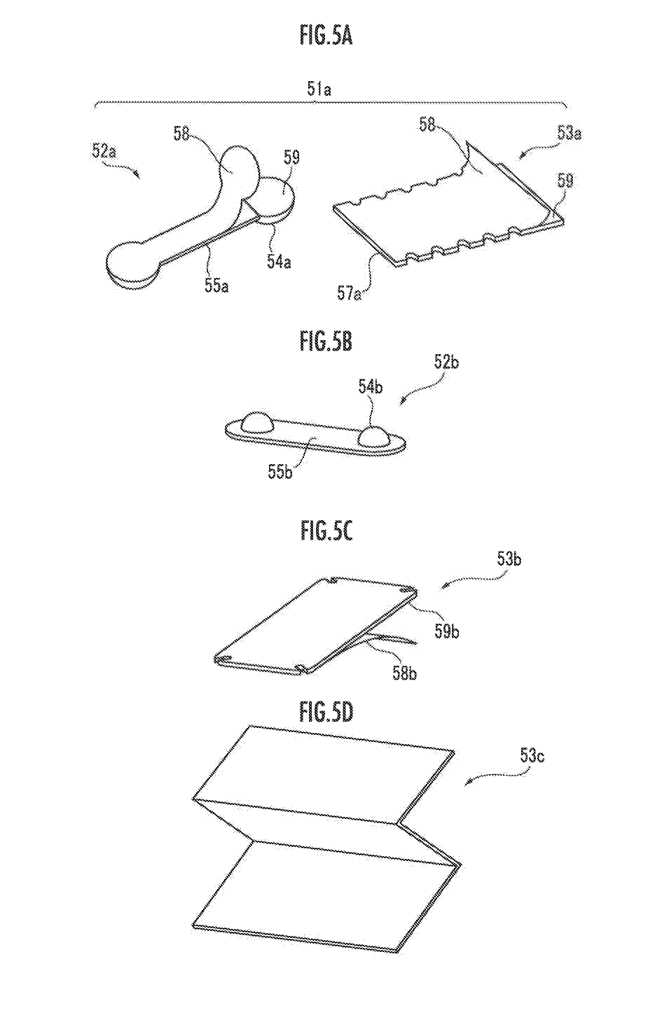

Next, an explanation will be made of a tool 51a for 3D adjustment of a muscle position in a fourth embodiment as a variation of the third embodiment. The tool 51a for 3D adjustment of the muscle position in the fourth embodiment includes a first member 52a and a second member 53a (FIG. 5A). A width, a length and the like of each of the first member 52a and the second member 53a may be approximately identical to those in each of the first member 52 and the second member 53 in the third embodiment.

The first member 52a includes two convex parts 54a and a connecting member 55a connecting the convex parts 54a. The convex part 54a may be, as similar to the third embodiment, formed in a doom shape, in a spherical shape or in a shape in imitation of the condyle of a patient.

The first member 52a has an adhesive surface 59 that is the connecting member 55a and flat portions at the opposite side to convex parts of the convex parts 54a. The second member 53a has both surfaces that are substantially flat and one of which is formed as the adhesive surface 59. The first member 52a and the second member 53a both separate a separated sheet 58 overlapped on the adhesive surface 59 to be arranged on a wax rim with the adhesive surface 59. The adhesive surface 59 may be configured as a material having adhesive properties such as a double-faced tape, which is applied on the connecting member or may be formed by applying an adhesive material, overlapping the separated sheet 58 thereon.

The tool 51a for 3D adjustment of the muscle position in the fourth embodiment attaches the pair of the second members 53a in positions corresponding to the left and right molar regions in the lower jaw side of a patient after attaching the occlusal rim to the patient. At this time, the second member 53a is attached in such a manner that the second plate-shaped member 57a is flush with the occlusal flat surface of a patient.

Next, the first member 52a is attached in such a manner that the convex part 54a causes the first member 52a having the convex parts 54a to abut on the second plate-shaped member 57a when the occlusal movement is performed in the mouth cavity of a patient. As described above, the attachment of the second member 53a and the first member 52a may be performed by separating the separated sheet 58 and cause the first member 52a to adhere on the wax rim by the adhesive surface 59. The process from occlusal movement to production of the dentures may be performed in the same way as the third embodiment.

An example of a variation of embodiment 4 provided with an adhesive part is shown (FIG. 5B to FIG. 5D). FIG. 5B illustrates a variation of a first member. A first member 52b is formed such that two convex parts 54b are disposed on a plate-shaped connecting member 55b. Here, an adhesive part is disposed at a surface at the opposite side to a surface provided with the convex parts, but not the adhesive part but a sharp part may be disposed.

FIG. 5C illustrates a variation of a second member. A second member 53b is configured in the same way as the second member 53a illustrated in FIG. 5A except that slits are formed in four corners to cause silicon impression materials and paraffin wax to be entangled. A separated sheet 58b is separated to expose an adhesive surface 59b, thus making it possible to adhere to the occlusal rim. Without mentioning, not the adhesive surface but a sharp part may be disposed.

A second member 53c illustrated in FIG. 5D is configured to fold a plurality of plate-shaped members. The configuration of adhering to the occlusal rim by the adhesive surface for use is the same as the second member in the other embodiments, but in a case of the height adjustment, the folded member is unfolded, making it possible to adjust the second member to an appropriate height. In addition, when a slit is formed on a fold mountain portion to be capable of being easily cut, the occlusal adjustment can be performed more smoothly.

### Embodiment 5

Next, a fifth embodiment is shown. In the present embodiment, for adjustment of a centric position and a centric occlusal position, a first member is not installed on an occlusal rim but can be used with the gripping of an operator. Any of the second members in embodiment 3 and embodiment 4 may be used as a second member.

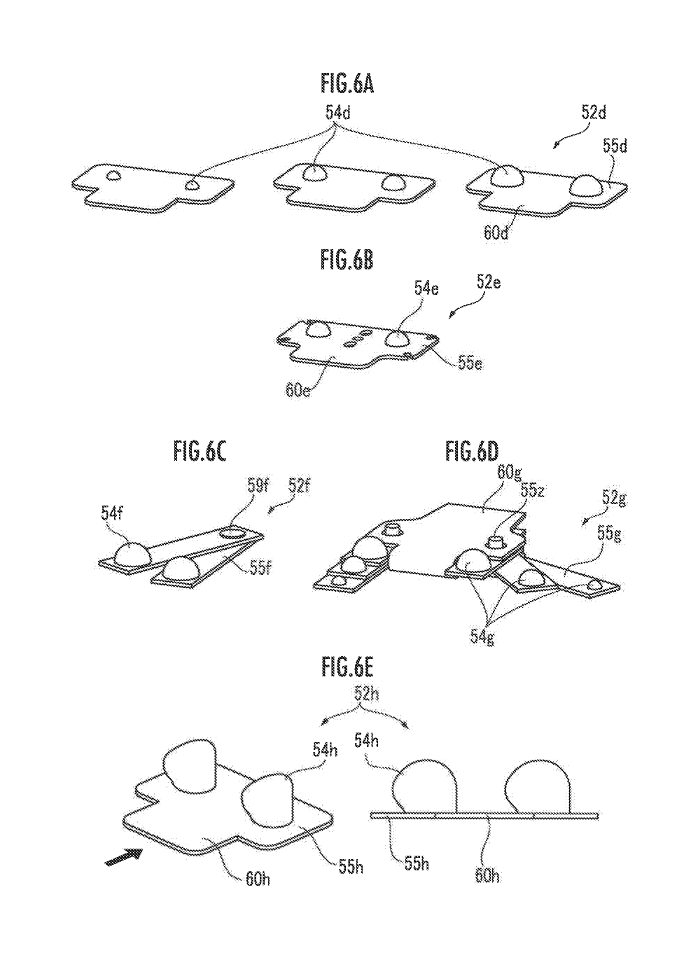

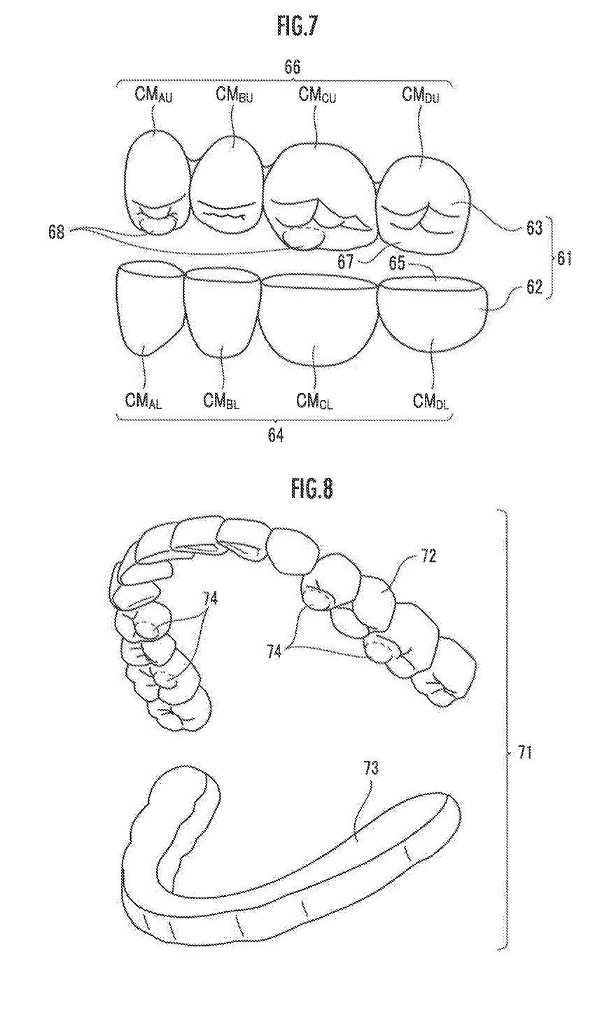

A first member 52d is prepared such that convex parts 54d different in size are disposed on connecting members 55d (FIG. 6A). The connecting member 55d is provided with a gripping part 60d at one side, and an operator can use the first member 52d by gripping the gripping part 60d with an occlusal sheet holder etc. in the mouth cavity of a patient. The first member 52d is sized to have a width of approximately 5.0 to 55.0 mm and a length (dentition direction) of approximately 5.0 to 65.0 mm including the gripping part 60d. A patient is caused to perform an occlusal movement, and a first member appropriate for the centric position to correspond to the centric occlusal position may be selected. There may be prepared the first members each having a height of the convex part 54d from the connecting member 55d, the height being in a range of approximately 0.5 to 20 mm and having a height difference between the members of 2 mm or less. Here, the first member having the convex parts different in size has been shown, but the first members having various condylar shapes are prepared and an adapted one of them may be selected. In addition, a variation of the fifth embodiment illustrated in FIG. 6 may be also of the same size with the fifth embodiment. After an appropriate first member is selected, by causing the first member to adhere to the occlusal rim, denture production in which the centric position corresponds to the centric occlusal position can be performed in a dental technical center. The first member with the adhesive surface or the sharp part may be used or may be fixed by paraffin wax.

A first member 52e with a connecting member 55e having slits or holes on the four corners and the center for paraffin wax or the like to be easily entangled is shown. Here, the holes are formed between two convex parts 54e, but holes may be formed outside of the convex parts 54e. The slits as well are not formed in the corners, but a plurality of slits may be formed in the periphery. Further, here, the first member 52e provided with a gripping part 60e is shown but may be configured without a gripping part.

A first member 52f is shown as a variation with a plurality of members each having one plate-shaped member 55f provided with a convex part 54f The first member 52f is configured such that one ends of the plate-shaped members 55f provided with the convex parts 54f of the same size are overlapped and a retainer 59f retains the plate-shaped members 55f to be capable of opening/closing. After the second member is installed in the mouth cavity of a patient as described above, the first members 52f open to each other having an appropriate interval to perform the adjustment of the centric position and the centric occlusal position. An operator grips a connected end of the retainer side with an occlusal sheet holder to let the patient perform an occlusal movement and confirm whether the convex part 54f of the selected first member 52f is appropriate in size. The first member provided with the larger or smaller convex part is used to be capable of performing the adjustment.

A first member 52g may be configured to have a plurality of plate-shaped members 55g provided with convex parts 54g different in size. The plate-shaped members 55g provided with the convex parts different in size or in shape are each provided with a hole (unillustrated) at the opposite side to the convex part 54g and are connected to be rotatable to each other by a pin 55z projecting from the lower side of the plate-shaped member 55g. While the plate-shaped member 55g is held in the mouth cavity of a patient by the occlusal sheet holder through an integral member provided with a gripping part 60g, an appropriate size or shape of the convex part can be confirmed.

An example in which a convex part is formed in a condylar shape is shown. FIG. 6E is a perspective view of a first member 52h to be installed in a left and lower occlusal rim of a patient (FIG. 6E left) and is a side view as viewed from a direction indicated by an arrow in FIG. 6E left (FIG. 6E right). Two convex parts 54h in imitation of a condylar shape are disposed in a connecting member 55h. Here, the convex part 54h that is often adopted as a shape of the condyle is shown as an example. A plurality of the convex parts 54h that are often adopted as a shape of the condyle in health people, aged people, edentulous people or the like are prepared, and then a convex part approximate to the condylar shape of a patient may be selected. In addition, a condylar portion may be produced by a 3D printer to be used, based upon an X-ray picture of a patient preliminarily taken. The configuration of disposing the gripping part 60h on one side of the connecting member 55h is similar to that of the first member as shown above.

In a case of using a first member installed on the right and lower occlusal rim of a patient, a gripping part may be disposed at the opposite side. In a case of installing a first member on the upper occlusal rim of a patient, a convex part used may be one installed to an inclined surface to which an arrow-shaped jaw path corresponds.

As explained above, any operator can adjust the jaw position with good accuracy by using the first member provided with the convex part and the second member provided with the flat part. The embodiments as described above are shown as only examples, and as long as the first member is provided with the convex part and the second member is provided with the flat surface, the first member and the second member may include various modifications.

### Embodiment 6

After the jaw position is adjusted by any tool for 3D adjustment of the muscle position of the first to fifth embodiments as described above, an artificial tooth 61 for trial application of a muscle position illustrated in FIG. 7 is used to reconfirm a position of a lower jaw to an upper jaw and an outside appearance when the dentures are attached, and after that, final dentures are produced. An explanation will be made of the configuration and the use method of the artificial tooth 61 for trial application of the muscle position with reference to FIG. 7.

FIG. 7 illustrates an aspect of the artificial tooth 61 for trial application of the muscle position. The artificial tooth 61 for trial application of the muscle position is provided with a pair of lower members 62 adhered to left and right molar regions of a lower jaw occlusal rim R_{L}, and a pair of upper members 63 adhered to portions, which oppose the lower members 62, of an upper jaw occlusal rim R_{U}. The lower member 62 and the upper member 63 are made of resin such as composite resin or acryl resin. In addition, a 3D printer or a CAD-CAM may be used to produce members tailored to a body type, and sizes of an upper jaw and a lower jaw of a patient.

The lower member 62 is composed of a first tooth crown model 64 by connection of four tooth crown models CM_{AL}, CM_{BL}, CM_{CL}, CM_{DL} in imitation of a first premolar tooth, a second premolar tooth, a first molar tooth and a second molar tooth of a lower jaw. The first tooth crown model 64 is formed in a substantially L-letter shape in section view to be capable of adhering to the lower jaw occlusal rim R_{L} and the occlusal surface 65 is formed in a substantially flat surface.

The upper member 63 is composed of a second tooth crown model 66 by connection of four tooth crown models CM_{AU}, CM_{BU}, CM_{CU}, CM_{DU} in imitation of a first premolar tooth, a second premolar tooth, a first molar tooth and a second molar tooth of an upper jaw. The second tooth crown model 66 is formed in a substantially L-letter shape in section view to be capable of adhering to the upper jaw occlusal rim R_{U} and an occlusal surface 67 is provided with two second convex parts 68 projecting from the occlusal surface 67, the second convex part 68 having a diameter of 1.0 to 4.5 mm and a height of 0.1 to 12.0 mm, preferably 1.0 to 4.5 mm.

A plurality of the first tooth crown models 64 and a plurality of the second tooth crown models 66 having teeth different in size are prepared for arrangement of molar teeth to be adapted for a patient. Further, a plurality of the second convex parts 68 different in size and in shape are prepared, and the second convex part fit for a patient can be selected. As described above, since the shape of the condyle varies depending upon a patient, the convex part having the shape approximate to the condyle of each patient is selected to adjust the jaw position, thereby making it possible to perform the adjustment of the jaw position with better accuracy.

The first tooth crown model 64 and the second tooth crown model 66 illustrated in FIG. 7 are provided for a left-hand use, but the first tooth crown model 64 and the second tooth crown model 66 for a right-hand use are formed symmetrically to those illustrated in FIG. 7. In addition, in the present embodiment, the two second convex parts 68 are formed in the second tooth crown model 66, but three or four second convex parts 68 may be formed. In FIG. 7, the second convex part is configured to be disposed on the upper member 63, but a convex part may be disposed on a lower member and an upper member may be formed with an occlusal surface in a flat shape. Further, a dental cusp position as well may be disposed in a tongue side as illustrated in FIG. 7 or in a cheek side. The convex member may be formed by adhesion of a doom-shaped member having a diameter of 1.0 to 6.0 mm and a height of 0.1 to 12.0 mm, preferably 0.3 to 6.0 mm.

The artificial tooth 61 for trial application of the muscle position will be used as follows after the jaw position is adjusted by using any one of the above tools for 3D adjustment of the muscle position. Here, an explanation will be made of a case using the tool 31 for 3D adjustment of the muscle position in the second embodiment. After the bite taking is performed by the tool 31 for 3D adjustment of the muscle position, the artificial tooth 61 for trial application of the muscle position is attached and fixed on the articulator by a dental mechanic in such a manner that a position of the model for the upper and lower jaw work is not out of alignment by fixing the upper and lower sides with silicon impression materials. At this time, for causing the second member 33 to abut on the convex part 41 of the first member 32, the lower jaw occlusal rim R_{L} is aligned to the upper jaw base floor BP_{U}, resulting in a state where an optimal lower jaw position of a patient is reproduced.

Next, after the first member 32 is removed from the upper jaw base floor BP_{U}, the upper jaw occlusal rim R_{U} is applied to the upper jaw base floor BP_{U}, and, further, the second tooth crown model 66 is caused to adhere to the upper jaw occlusal rim R_{U} in such a manner that the second convex part 68 of the second tooth crown model 66 abuts on the second member 33.

Subsequently, the second member 33 is removed from the lower jaw occlusal rim R_{L}, and, next, the first tooth crown model 64 is caused to adhere to the lower jaw occlusal rim R_{L} in such a manner that the occlusal surface 65 of the first tooth crown model 64 abuts on the second convex part 68 of the second tooth crown model 66. When the first tooth crown model 64 and the second tooth crown model 66 adhere in this order, the first tooth crown model 64 and the second tooth crown model 66 can be attached to the upper and lower jaw occlusal rims R_{L}, R_{U} without losing the lower jaw position acquired by the bite taking.

Next, the lower jaw base floor in which the first tooth crown model 64 adheres to the lower jaw occlusal rim R_{L} and the upper jaw base floor BP_{U} in which the second tooth crown model 66 adheres to the upper jaw occlusal rim R_{U} are attached in the mouth cavity of a patient by a dentist, and the outside appearance at the time the final dentures are attached to the patient is confirmed.

Subsequently the occlusal movement is performed, and distal ends of the second convex parts 68 of the second tooth crown model 66 abut on the flat occlusal surface 65 of the first tooth crown model 64 following the occlusal movement. Thereby in a state where the distal ends of the four second convex parts 68 abut slide on the flat occlusal surface 65, it is possible to confirm the lower jaw position to the upper jaw when the final dentures are attached to a patient. Thereafter, the first tooth crown model 64 and the second tooth crown model 66 are taken out of the mouth cavity of the patient together with the lower jaw base floor and the upper jaw base floor BP_{U}, and the final dentures are formed by a dental mechanic.

In a case where the first member having the convex parts is arranged in the lower side as described in the first embodiment, the convex parts may be arranged to the lower member to perform the adjustment of the jaw position. As in the case of the third embodiment, also in a case where the adjustment of the jaw position to both the upper and lower is performed on the occlusal rim, the second member provided with the second plate-shaped member 57 is taken out of the wax rim, and the first tooth crown model 64 provided with the flat occlusal surface may be attached instead of this. Next, the first member 52 provided with the convex parts 54 is taken out, and the second tooth crown model 66 provided with the second convex parts 68 approximate to the shape of the condyle of a patient may be used in replacement of the first member 52.

By using the tool for 3D adjustment of the muscle position, the 3D sheet for anterior tooth provisional arrangement and the artificial tooth for trial application of the muscle position as described above, the alignment of the lower jaw at the bite taking can be performed with good accuracy. Therefore, it is possible to produce the final dentures without producing the wax dentures and shorten a time required for the whole process of the denture production.

In this way, when the tool for 3D adjustment of the muscle position is used, it is possible to cause the centric position of a patient to correspond to the centric occlusal position of the patient for a short time. Therefore, not only a load of a patient can be reduced, but also a load of a dentist can be reduced to be small.

### Embodiment 7

Next, an explanation will be made of an artificial tooth 71 for trial application of a muscle position to be used for medical treatment. In a state where the jaw position is out of alignment, a joint disc in the inside of a jaw joint is out of alignment inward or forward or backward from an original position, that is, there occurs a state like the joint is slipped, which possibly causes inconvenience or a pain in occlusion. In this state, the original movement of the jaw is limited to change the occlusion, possibly bringing out troubles in a daily life. Also, in a case of performing sprint medical treatment, it is possible to adjust the deviation of the jaw position by using the artificial tooth 71 for trial application of the muscle position in the present embodiment.

The artificial tooth 71 for trial application of the muscle position can be, as illustrated in FIG. 8, configured as a tooth crown model to cover all of upper teeth and lower teeth. The artificial tooth 71 for trial application of the muscle position as illustrated in FIG. 8 is composed of an upper member 72 to cover the upper teeth and a lower member 73 to cover the lower teeth. The upper member 72 and the lower member 73 both are made of resin. The upper member 72 to cover the upper teeth is basically formed in a shape to cover original upper teeth of a patient and is provided with second convex parts 74 on left and right first premolar regions and first molar regions of the upper jaw. The second convex part 74 may be formed integrally with the upper member 72 to form a convex part on the first premolar region and the first molar region of the upper member 72, but the second convex part 74 may be formed by causing a convex-shaped member to adhere to the upper member 72 formed to cover a shape of a tooth of a patient. The second convex part 74 may be formed in a doom shape or in a shape approximate to a condyle of a patient.

In a case of forming the second convex part 74 by adhesion of the doom-shaped member, the convex-shaped member is formed of a doom-shaped member having a diameter of 1.0 to 6.0 mm and a height of 0.1 to 12.0 mm, preferably 0.3 to 6.0 mm, and for easy work at the adhesion, a fringe part may be disposed in the periphery of the convex part. A size of the convex-shaped member may be optionally selected corresponding to the body type of a patient.

The lower member 73 opposing this second convex part 74 has an upper region that is formed in a flat shape to cover the whole lower teeth. The lower member 73 is formed as stabilization sprint in which portions in contact with the opposing upper teeth are substantially flat. Since the lower member 73 is of a shape similar to the stabilization sprint, an area of contact points of the upper teeth composed of the second convex parts 74 and contact points with the lower jaw becomes minimized, which causes smooth transfer of the lower jaw position, making it possible to guide a natural transfer of the jaw position of a patient irrespective of the level of skill of an operator.

Here, the explanation has been made of the structure where the second convex part 74 is disposed as the upper member and the lower member is formed in the stabilization sprint shape, but the upper member may be formed in the stabilization sprint shape and the second convex part may be disposed on the lower member.

### Embodiment 8

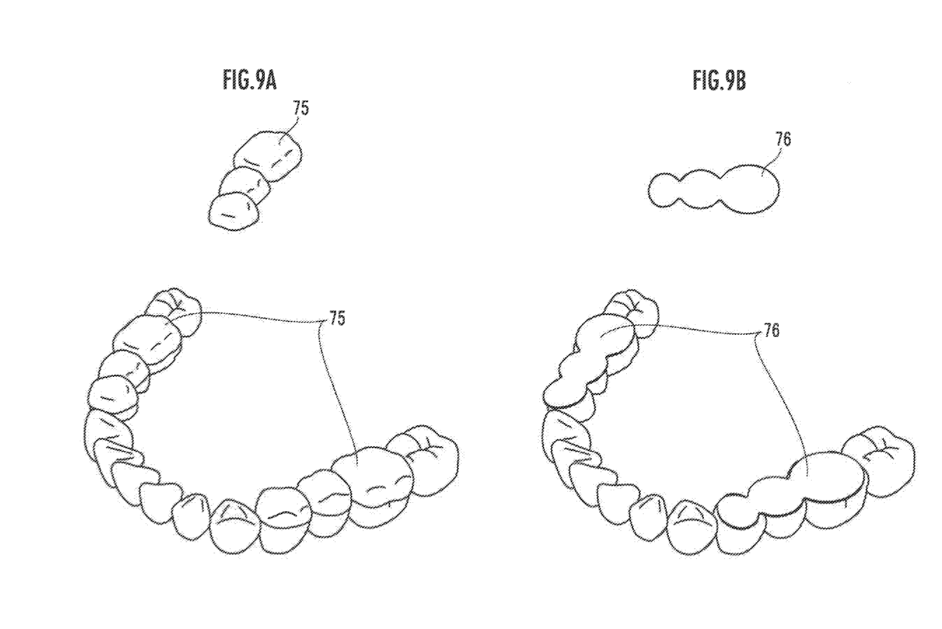

Next, an explanation will be made of a variation of an artificial tooth for trial application of a muscle position for medical treatment (FIG. 9A and FIG. 9B). FIG. 9A illustrates an example of an artificial tooth for trial application of a muscle position devised for flattening an occlusal surface of only portions corresponding to left and right first premolar teeth and first molar region in which the convex parts 74 of the upper member are positioned. The lower member 75 covers only from the left and right first premolar teeth to the left and right first molar region of the lower teeth and is formed such that the occlusal surface becomes flat. The lower member 75, depending upon how much a loss of the installation region of the lower member 75 is generated, has a thickness of approximately 0.1 to 12.0 mm. Since the portion with which the second convex parts 74 come in contact is formed to be substantially flat, achieving the effect as similar to the sprint.

A lower member 76 illustrated in FIG. 9B is used by adhering from the left and right first premolar teeth to the left and right first molar region of the lower teeth. The lower member 76 as well, depending upon how much a loss of the installation region of the lower member 76 is generated, has a thickness substantially identical to that of the lower member 75. Since the flat occlusal surface is formed by the lower member 76, it is possible to perform the adjustment of the jaw position as similar to the sprint.

### Embodiment 9

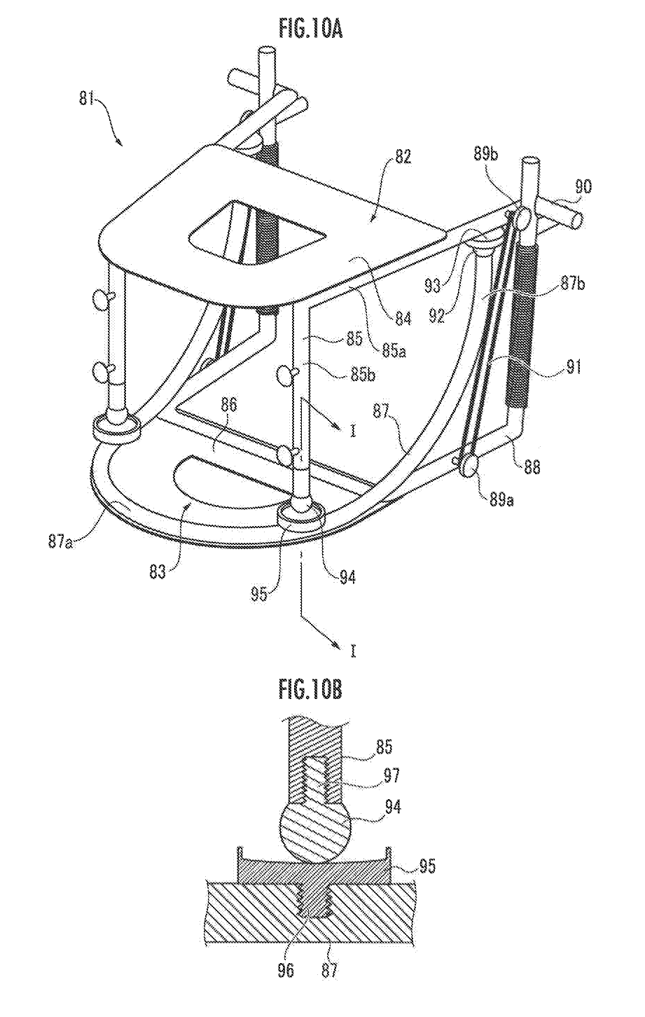

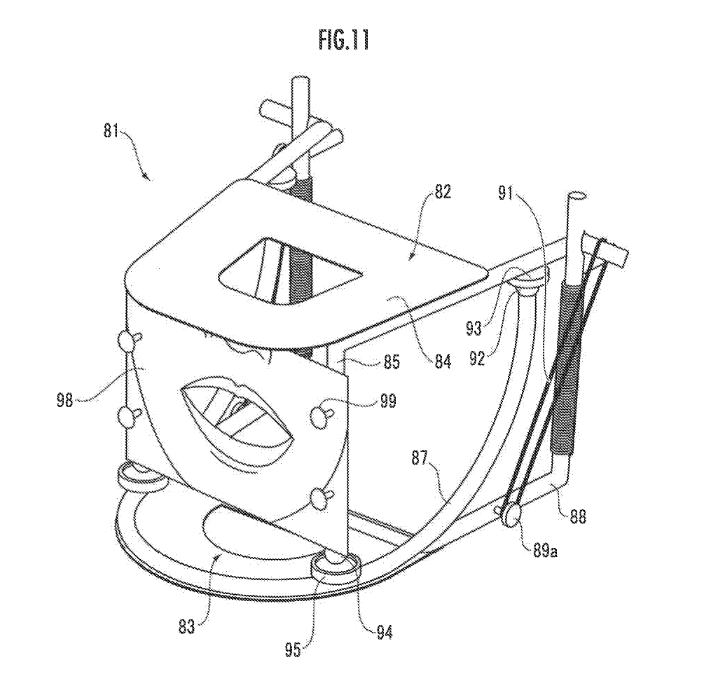

Next, an explanation will be made of an articulator (articulator for 3D adjustment of a muscle position) appropriate for the adjustment of the jaw position by using the tool for 3D adjustment of the muscle position in the present embodiment (FIG. 10). An articulator 81 for 3D adjustment of a muscle position in the present embodiment is, for reproduction of jaw movements, an articulator provided with components in imitation of a shape of a joint glenoid cavity and a joint disc that are supposed to give a big impact on jaw movements in the mouth cavity. A state of the jaw glenoid cavity or the joint disc of a patient differs depending upon abrasion due to aging or a difference between left and right shapes, but a component of a shape close to the state of a patient is selected for replacement, which provides an articulator enabling the state close to the state of the jaw of the patient to be reproduced.

The articulator 81 for 3D adjustment of the muscle position includes an upper arch part 82 configuring an upper arch corresponding to an upper jaw and a lower arch part 83 configuring a lower arch corresponding to a lower jaw. The upper arch part 82 includes a plate-shaped upper arch member 84 and a pair of L letter-shaped upper arch supports 85. The pair of the upper arch supports 85 include an upper arch support horizontal part 85a adhering to the upper arch member 84 in the left and right respectively and an upper arch support vertical part 85b descending vertically from the upper arch member 84. As illustrated in FIG. 10, the upper arch support horizontal part 85a adheres along both ends of the upper arch member 84 in the left and right, and the upper arch support vertical part 85b is configured as a pair of left and right members descending vertically as members continuous from the left and right upper arch support horizontal parts.

The lower arch part 83 includes a lower arch member 86, a pair of left and right lower arch supports 87 bent toward the backside of the upper arch support 85 from the front of the lower arch member 86, and a pair of left and right L letter-shaped lower arch structures 88 extending horizontally to the backside from a rear end of the lower arch member 86 and rising vertically in the backside. The lower arch support 87 includes a lower arch support horizontal part 87a adhering to the lower arch member 86 and configuring a part of the lower arch part, and a lower arch support upward part 87b extending toward the upper arch part 82 backwards. The lower arch support upward part 87b is here formed as a shape bending and extending to the backward but may be formed as a linear member extending to the backward of the upper arch support 85.

The upper arch support 85 is provided with a bending part 90 projecting toward the outside at a backward upper end and is formed to be combined with the upward side of the lower arch structure 88. The lower arch structure 88 is provided with a projection 89a in back of a rear end of the lower arch member 86. The upper arch support 85 is provided with a projection 89b in front of the bending part 90. The projection 89a and the projection 89b are retained by a resilient member 91 such as a rubber band or by a spring (refer to FIG. 10A). The projection 89a and the bending part 90 may be retained by the resilient member 91, the spring or the like without the projection 89b (refer to FIG. 11).

An upper end of the lower arch support 87 is provided with a condylar convex part 92 having a convex part and abuts slidably on a condylar receiver 93 formed in a downward cup or substantially flatly in the backward of the upper arch support 85. A pair of left and right condylar parts are formed by the condylar convex part 92 and the condylar receiver 93. Here, the condylar convex part 92 is disposed in the upper end of the lower arch support 87 and the condylar receiver 93 is disposed in the backward of the upper arch support 85, but a condylar receiver may be disposed in the upper end of the lower arch support 87 and a condylar convex part may be disposed in the backward of the upper arch support 85.

Further, an auxiliary condylar convex part 94 formed spherically in a lower end of the upper arch support vertical part 85b abuts slidably on an auxiliary condylar receiver 95 formed in a downward cup or substantially flatly in the lower arch support horizontal part 87a. An auxiliary condylar part is formed of the auxiliary condylar convex part 94 and the auxiliary condylar receiver 95. As to the auxiliary condylar convex part and the auxiliary condylar receiver, similarly, the auxiliary condylar receiver may be disposed in the upper arch support vertical part 85b and the auxiliary condylar convex part may be disposed in the lower arch support horizontal part 87a.

In the embodiment of the articulator illustrated in FIG. 10, the upper arch part and the lower arch part are configured to be movable relatively in a total of four components composed of the pair of the left and right condylar parts disposed in the upper arch part 82 and the pair of the left and right auxiliary condylar parts disposed in the lower arch part. For that reason, it is possible to cause the centric position to correspond to the centric occlusal position easily at the denture production.

In addition, although herein not illustrated, in other embodiments, the configuration that the upper arch support horizontal part 85a adheres along both ends of the upper arch part in the left and right is adopted in the same way, but the upper arch support vertical part 85b may be configured as one member that descends vertically from the front center of the upper arch part and as a member different from the upper arch support horizontal part. That is, the upper arch part and the lower arch part may be configured to be capable of sliding by an auxiliary condylar part existing in the front center of the lower arch part and a pair of two left and right condylar parts positioned in the backward of the upper arch part. In a case of one upper arch support vertical part, a shape of the auxiliary condylar convex part may be formed in a shape like a conventional guide nail. Even in a case where the auxiliary condylar convex part is made to be the shape of the conventional guide nail, since the condylar part is disposed in the backward, the movability in imitation of the movement of the lower jaw is guaranteed.

The articulator for 3D adjustment of the muscle position in the present embodiment can achieve reproduction of a three-dimensional movement because of point contact of the upper arch support and the lower arch support in the artificial condyle and the artificial jaw joint, which is different from the upper arch support and the lower arch support of the conventional articulator. As a result, in the prosthetic appliance of full jaw medical treatment, the centric position is caused to correspond to the centric occlusal position to more easily produce dentures. In addition, in the prosthetic appliance of partial medical treatment, it is easy to produce dentures of long-centric and wide-centric having a freedom of front/back sliding movement and side sliding movement of a jaw. As a result, early contact removal between the centric position and centric occlusal position becomes easy.

FIG. 10B illustrates a cross section in a position of I-I in FIG. 10A. A screw part 96 is formed in a lower side of an auxiliary condylar receiver 95, which is screwed in a screw hole formed in the lower arch support 87. In addition, since a screw part 97 is formed in a convex part of an auxiliary condylar convex part 94 as well, which abuts on the auxiliary condylar receiver 95, the auxiliary condylar convex part 94 is replaceable. A convex-shaped portion of each of the condylar convex part 92 and the auxiliary condylar convex part 94 is close to a shape of a condyle of a patient, and a depth of a recessed portion of each of the condylar receiver 93 and the auxiliary condylar receiver 95 is close to a shape of the jaw joint cavity or formed flatly. A plurality of the above convex parts and receivers are prepared. Here, the auxiliary condylar convex part 94 and the auxiliary condylar receiver 95 have been explained, but the condylar convex part 92 and the condylar receiver 93 are likewise replaceable by screws and can be formed to be approximate to a shape of a condyle of a patient. The jaw joint cavity and the condyle become worn and flat at aging, but a convex-shaped member and a recessed member close to a joint shape of a patient are selected based upon age of the patient or information acquired by X-ray shooting, which enables the jaw movement of the patient to be reproduced. In some cases, left and right condylar shapes are different depending upon patients, but since the articulator is detachably attached by screws in such a way, the articulator can respond to a case where the left and right condylar shapes are different.

Since the articulator 81 for 3D adjustment of the muscle position in the present embodiment has three or four abutting points of the backward left and right condylar parts (abutting parts 92, 93) and the forward left and right auxiliary condylar parts (abutting parts 94, 95), simultaneous contact by the two points of the condyles situated outside of the contact point of a technical material such as the mounted model is prioritized. Therefore, the condyle is difficult to float, making it possible to acquire the stable jaw position.

The model for upper and lower jaw work produced by the tool for 3D adjustment of the muscle position in the present embodiment is attached and fixed to the articulator 81 for 3D adjustment of the muscle position to produce final dentures. A lip sheet 98 by taking a picture of the shape of lips of a patient may be retained to the articulator 81 for 3D adjustment of the muscle position by pins 99 (FIG. 11). The model for upper and lower jaw work is not illustrated in FIG. 11, but while a lip position is confirmed by the lip sheet 98, the artificial tooth arrangement can be performed. Therefore, it is possible to easily perform the selection of an artificial tooth adapted for the shape of the lips of the patient. In addition, the artificial tooth arrangement as well can be arranged while watching a balance with the facial feature of a patient because of the presence of the lip sheet 98. As a result, the time for the denture production can be made short.

By using the tool for 3D adjustment of the muscle position and the articulator for 3D adjustment of the muscle position shown in the present embodiments, it is possible to easily cause the centric position of a patient having lost a jaw position to correspond to the centric occlusal position even by an operator not experienced well.

### REFERENCE SIGNS LIST

1, 31, 51, 51a: TOOL FOR 3D ADJUSTMENT OF MUSCLE POSITION
2, 32, 52, 52a, 52b, 52d, 52e, 52f, 52g, 52h: FIRST MEMBER
3, 33, 53, 53a, 53b, 53c: SECOND MEMBER
4: INSTALLATION MEMBER
5, 37: FIRST PLATE-SHAPED MEMBER
6, 36: SCREW MEMBER
7: RECEIVER
8: DISENGAGEMENT PREVENTIVE MEMBER
9, 41, 54, 54a, 54b, 54d, 54e, 54f, 54g, 54h: CONVEX PART
10: POSITIONING MEMBER
11: DEPRESSION
12, 38: ENGAGING PROJECTION
13: POSITIONING HOLE
21: 3D SHEET OF ANTERIOR TOOTH PROVISIONAL ARRANGEMENT
22: UPPER TOOTH ARRANGEMENT DISPLAY PART
23: EXTENSION PART
24: ENGAGING PART
35: BASE
55, 55a, 55b, 55d, 55e, 55h: CONNECTING MEMBER
56: SHARP PART
57, 57a: SECOND PLATE-SHAPED MEMBER
58, 58b: SEPARATE SHEET
59, 59b: ADHESIVE SURFACE
59f: RETAINER
55f, 55g: PLATE-SHAPED MEMBER
60d, 60e, 60g, 60h: GRIPPING PART
61, 71: ARTIFICIAL TOOTH FOR TRIAL APPLICATION OF MUSCLE POSITION
62, 73, 75, 76: LOWER MEMBER
63, 72: UPPER MEMBER
64: FIRST TOOTH CROWN MODEL
65, 67: OCCLUSAL SURFACE
66: SECOND TOOTH CROWN MODEL
68, 74: SECOND CONVEX PART
81: ARTICULATOR FOR 3D ADJUSTMENT OF MUSCLE POSITION
82: UPPER ARCH PART
83: LOWER ARCH PART
84: UPPER ARCH MEMBER
85: UPPER ARCH SUPPORT
85a: UPPER ARCH SUPPORT HORIZONTAL PART
85b: UPPER ARCH SUPPORT VERTICAL PART
86: LOWER ARCH MEMBER
87: LOWER ARCH SUPPORT
87a: LOWER ARCH SUPPORT HORIZONTAL PART
87b: LOWER ARCH SUPPORT UPWARD PART
88: LOWER ARCH STRUCTURE
89a, 89b: PROJECTION
90: BENDING PART
92: CONDYLAR CONVEX PART
93: CONDYLAR RECEIVER
94: AUXILIARY CONDYLAR CONVEX PART
95: AUXILIARY CONDYLAR RECEIVER
96, 97: SCREW PART
98: LIP SHEET
BP_{U}: UPPER JAW BASE FLOOR
C1: UPPER JAW CUTTING TOOTH
CM_{AL}, CM_{AU}, CM_{BL}, CM_{BU}, CM_{CL}, CM_{CU}, CM_{DL}, CM_{DU}: TOOTH CROWN MODEL
R_{L}: LOWER JAW OCCLUSAL RIM
R_{U}: UPPER JAW OCCLUSAL RIM

1. A tool for 3D adjustment of a muscle position comprising:
a first member attached in a position corresponding to left and right molar regions; and
a second member attached in a position opposing the first member,
the first member being provided with a plurality of convex parts on a surface facing the second member, the convex parts having distal ends capable of sliding on an upper surface of the second member, and
the second member having a surface facing the first member, the surface being a substantially flat surface.

2. The tool for 3D adjustment of the muscle position according to claim 1, wherein
a shape of the plurality of the convex parts of the first member is a shape in imitation of a condyle of a patient.

3. The tool for 3D adjustment of the muscle position according to claim 1, wherein
the first member and the second member each include a plurality of sharp parts capable of being inserted in an occlusal rim and
are attached by inserting the sharp parts in the occlusal rim.

4. The tool for 3D adjustment of the muscle position according to claim 1, wherein
the first member and the second member each include an adhesive part capable of adhering to an occlusal rim and
adhere to the occlusal rim by the adhesive part.

5. The tool for 3D adjustment of the muscle position according to claim 1, wherein
the second member is formed in a sprint shape covering the whole dentition.

6. An articulator for 3D adjustment of a muscle position comprising:
an upper arch part for supporting an upper jaw model; and
a lower arch part for supporting a lower jaw model, wherein
the upper arch part includes an upper arch member and an upper arch support,
the lower arch part includes a lower arch member and a lower arch support,
the upper arch support includes an upper arch support horizontal part configuring the upper arch part adhered to the upper arch member and an upper arch support vertical part descending vertically in the forward side of the upper arch member,
the lower arch support includes a lower arch support horizontal part configuring the lower arch part adhered to the lower arch member and a lower arch support upward part extending toward the upper arch part backwards,
the upper arch part is provided in the backward side with a condylar part composed of a condylar convex part and a condylar receiver in the left and right respectively,
the lower arch member is provided at the front lower part with an auxiliary condylar part composed of an auxiliary condylar convex part and an auxiliary condylar receiver,
the condylar convex parts each are capable of sliding relative to the corresponding condylar receiver, and
the auxiliary condylar convex parts each are capable of sliding relative to the corresponding auxiliary condylar receiver.

7. The articulator for 3D adjustment of the muscle position according to claim 6, wherein
the condylar parts are disposed in the left and right one by one,
the condylar part is formed of a condylar convex part or a condylar receiver in a distal end of the lower arch support upward part, and
a condylar receiver or a condylar convex part in the backward side of the upper arch part,
when the condylar convex part is disposed in the distal end of the lower arch support upward part, the condylar receiver is disposed in the backward side of the upper arch part,
when the condylar receiver is disposed in the distal end of the lower arch support upward part, the condylar convex part is disposed in the backward side of the upper arch, and
the auxiliary condylar parts are disposed, one in the center of the lower arch or in the left and right one by one,
the auxiliary condylar part is formed of the auxiliary condylar convex part or an auxiliary condylar receiver in a lower end of the upper arch support vertical part, and
an auxiliary condylar receiver or an auxiliary condylar convex part in the forward side of the lower arch part,
when an auxiliary condylar convex part is disposed in the lower end of the upper arch support vertical part, an auxiliary condylar receiver is disposed in the forward side of the lower arch part, and
when an auxiliary condylar receiver is disposed in the lower end of the upper arch support vertical part, an auxiliary condylar convex part is disposed in the forward side of the lower arch part.

8. The articulator for 3D adjustment of the muscle position according to claim 6, wherein
the condylar convex part or the auxiliary condylar convex part is formed in a shape in imitation of a condyle of a patient, and
the condylar receiver or the auxiliary condylar receiver has a surface opposing the condylar convex part or the auxiliary condylar receiver, the surface being formed in a substantially flat surface or in a shape in imitation of a glenoid cavity of a patient.

9. The articulator for 3D adjustment of the muscle position according to claim 6, comprising:
a lip sheet arranging part configured to arrange a lip sheet of a patient.
